(19) United States
(12) Patent Application Publication
(10) Pub. No.: US 2011/0254845 A1
(43) Pub. Date: Oct. 20, 2011

(54) IMAGE PROCESSING METHOD AND IMAGE PROCESSING APPARATUS

(75) Inventors: Michio OIKAWA, Machida (JP); Hanae YOSHIDA, Yokohama (JP); Tomohiro NAGAO, Kashiwa (JP); Jiangtao GAO, Shanghai (CN); Qizhong LIN, Shanghai (CN); Yingjie HAN, Shanghai (CN)

(73) Assignee: HITACHI MEDICAL CORPORATION, Tokyo (JP)

(21) Appl. No.: 13/027,569

(22) Filed: Feb. 15, 2011

(30) Foreign Application Priority Data
Apr. 16, 2010 (CN) 201010163949.5

(51) Int. Cl. G06T 15/10

(52) U.S. Cl. 345/427

(57) ABSTRACT

The present invention proposes an image processing method and an image processing apparatus, in which an object of interest is selected in a three-dimensional scene by using information on a section parallel to a sight line, and a surface is generated to divide the line of sight passing through the object into two parts, so as to display the user-interested object through an opaque area by establishing different rendering parameters for the two parts of the sight line.

### CLAIM OF PRIORITY

The present application claims priority from Chinese patent application 201010163949.5 filed on Apr. 16, 2010, the content of which is hereby incorporated by reference into this application.

### BACKGROUND

The present invention relates to the field of three-dimensional image display, more particularly, relates to a display method and apparatus of three-dimensional data, which provides a method for selecting object of interest in a three-dimensional scene by using information on a section parallel to a sight line, and rendering a two-dimensional image of the selected object along the sight line.

With the rapid development of information technology, the data obtained from calculation and measurement techniques is increased in an incredible speed. In the next few years, the amount of information produced and collected by human being will exceed the total amount of information that human being has obtained so far. This makes extracting meaningful information, quick and efficiently, from a large amount of information become more and more difficult. In order to solve this problem, scientists have proposed a variety of models and methods, and one of them is the visualization technology. The visualization technology is used for getting meaningful information from a large amount of basic data, and showing it to the user by means of interactive computer graphics techniques for the purpose of a better understanding of information and a quick decision-making. The visualization is mainly classified into two types: scientific computing visualization and information visualization. The scientific computing visualization pays attention to the physical data, such as human body, earth and molecular etc., while the information visualization is used for abstract non-physical data, such as text and statistics data etc. Here, the attention is mainly focused on scientific computing visualization which is such a technology that the data produced in the process of scientific computation is converted, by means of computer graphics and image processing techniques, into graphics and images which are shown to the user through a display device, so as to enable the user to perform interactive processing of the data. The application field of scientific computing visualization is very wide, mainly covering the fields of medicine, geological exploration, meteorology, molecular modeling, computational fluid dynamics and finite element analysis etc. Wherein, the medical data visualization is a very important application, the medical data is mainly obtained from medical imaging devices after measuring the structure and function of human tissues, such as computed tomography (CT) scan data and NMR (nuclear magnetic resonance) data.

At present, the core of scientific computing visualization technology is the visualization for three-dimensional space data field, all the medical imaging data, such as CT data, are regularized three-dimensional space grid data, and the data distributed on the discrete grid points in a three-dimensional space are obtained from an interpolation operation after performing CT scan or random sampling to three-dimensional continuous data field. The function of three-dimensional space data field visualization is to convert the discrete three-dimensional grid data field to a two-dimensional discrete signal in a frame buffer of a graphic display device according to a certain rule, i.e., generating color values (R, G, B values) of each pixel. A two-dimensional image reconstructed from the three-dimensional scene represents a complex three-dimensional scene from a specific visual angle, the user can change the position of view point by using computer graphics interactive technique to reconstruct the three-dimensional scene from different visual angles, thereby achieving knowledge and understanding of complex three-dimensional scenes. A typical application of three-dimensional space data field visualization is the visualization of CT data. A doctor can obtain the scan data of a patient's specific part from a CT device, and import it into a three-dimensional visualization device, then observe the specific part from different view points through the use of interactive technique, and from which obtain the structure and shape of specific human tissues, thereby, positioning the location of lesions and achieving a rapid diagnosis for patients. With the development of medical imaging devices, the amount of medical data is increasing by several times, and the three-dimensional data field visualization technology greatly increases the working efficiency of radiologists, that makes it possible to position and diagnose lesions more rapidly. In addition, the computer simulation surgery and planning for orthopedic surgery and radiotherapy etc. can also be implemented through the data interactive operation based on this technique.

Volume rendering technology is a very important three-dimensional display technique in the scientific computing visualization, and it is widely used in the field of medical image display with fine display accuracy. The data generated by modern computer tomography devices are the discrete data distributed on a three-dimensional space grid (a point on the grid is called ‘voxel’). The function of volume rendering algorithm is to convert the discrete three-dimensional data to a two-dimensional discrete signal in a frame buffer of a graphics display device according to a certain rule, i.e., generating color values (R, G, B values) of each pixel. The most commonly used method in volume rendering is the ray casting method which comprises mainly three steps. Firstly, data is classified according to the value of voxel, and different values of color and opacity are assigned to each kind of data so as to correctly indicate the different attributes of various matters, this process can be completed through the transfer function with which the value of a voxel is mapped to the values of color and opacity of the voxel. Secondly, three-dimensional data is re-sampled, that is, a light ray passing through the three-dimensional data is emitted from each pixel on the screen in the direction of sight line, and the equally-spaced sampling point is selected from the three-dimensional data along the light ray, and then, the values of color and opacity of the sampling point are obtained with the aid of interpolation according to eight voxels around the sampling point. Finally, the image synthesis processing is performed to synthesize the color value and opacity value of each sampling point on each light ray in the order from front to back or from back to front, thus, the color value of the pixel corresponding to the light ray is obtained, and the synthetic method is established by the synthetic function. Volume rendering can bring about more fine and rich effect by establishing different transfer functions, and this greatly increases the understanding of volume data.

In medical imaging fields, the image obtained from CT or MRI equipment are the grayscale image, however, there exists an overlapping in grayscale values between a variety of different tissues inside the human body, because the space distribution between tissues is extremely complex, usually, the three-dimensional reconstruction results of volume data obtained through the use of volume rendering technology contain plural tissues, and many tissues or its specific parts are obstructed by other tissues or itself, thus, it is unable for a doctor to carry on the diagnosis by means of the volume rendering technology, and this hindered the development of volume rendering technology in the medical field.

### SUMMARY

A common way to address this problem is to assign different transparency value and color for different tissues by establishing a transfer function. The assignment of the opacity and color is depending on the grayscale information of tissues, however, the grayscale of different tissues is often partially overlapped, such as in a CT image, fat and soft tissues have a similar grayscale range, blood and cartilage have a similar grayscale range, although bone has a high density and presents a high grayscale value in the CT image, the grayscale of its edges has a very wide range, and has covered the grayscale range of the blood and soft tissues, this make it difficult to achieve the purpose of showing the interested tissues emphatically. Although the multi-dimensional transfer function may use other information such as gradient etc., these multi-dimensional information still cannot accurately differentiate tissues.

Another common method to address this problem is extracting the tissues of interest from CT or MRI images by using the segmentation technique. In this way, we can control the rendering of different tissues in the rendering result by establishing different transfer functions for different tissues, however, it can not solve the part occluded by the object itself, many tissues have a complex space structure in medical images, and different parts within a tissue may obstruct each other. Since the segmentation method usually performs an overall segmentation for a tissue, it is impossible to identify the different part of a single tissue, therefore, we can not observe the specific part.

WO2006/099490 proposed a method of displaying an object of interest through an opaque object, in which the region of an opaque object is determined by using a fixed threshold value (grayscale or gradient) so as to control the synthesizing process of sampling points on the light ray, thereby, achieving the purpose of rendering the interested object through the opaque area. However, the method using fixed threshold can not make a correct judgment for the range of a complex opaque object.

Japan Patent Application Laid-Open Publication No. 2003-91735 proposed a method, wherein three-dimensional data is divided into several groups in a certain direction and each group of data generates a two-dimensional image in a particular manner (such as average value algorithm or maximum intensity projection algorithm), and the user-interested object is designated in such a group of two-dimensional images; then, the distance from the other voxels to the user-interest object in the three-dimensional data is calculated, and taken as a weighting factor in a synthetic function, for example, the voxel near to the object of interest has a higher weight, and the far voxel has a smaller weight, thus, the user-designated object can be highlighted by fuzzifying its surrounding area. However, this method needs that the designated object must be segmented wholly at the first, and it still can not display the parts occluded by other parts of the designated object itself.

In view of abovementioned background, the present invention proposes an image processing method, in which an object of interest is selected in a three-dimensional scene by using information on a section parallel to a sight line, and a surface is generated to divide the line of sight passing through the object into two parts, so as to display the user-interested object through an opaque area by establishing different rendering parameters for the two parts of sight line.

The present invention proposes a solution in other to solve the problem that the user-interested object occluded by other opaque object can not be rendered in a volume rendering. The object to be rendered is selected by using information on a section parallel to a sight line, and a two-dimensional segmentation curved surface is generated to separate the selected object from neighboring object in the direction of the sight line, so as to control the rendering process along the sight line, thereby, achieving the purpose of rendering the selected object individually.

According to the first aspect of the present invention, an image processing apparatus is proposed, which comprises: a segmentation curved surface generation unit for generating segmentation curved surface passing through a designated control point and intersecting with a first predetermined direction in accordance with three-dimensional image data; a first two-dimensional image generation unit for generating a first two-dimensional image in accordance with the projection of the three-dimensional image data on the segmentation curved surface; and a display unit for displaying the first two-dimensional image generated by the first two-dimensional image generation unit.

Preferably, the segmentation curved surface generated by the segmentation curved surface generation unit is substantially vertical to the first predetermined direction.

Preferably, the first two-dimensional image generation unit generates the first two-dimensional image in accordance with the projection of the three-dimensional image data on the segmentation curved surface along the first predetermined direction.

Preferably, the first two-dimensional image generation unit generates the first two-dimensional image in accordance with the projection of the three-dimensional image data on the segmentation curved surface along a direction opposite to the first predetermined direction.

Preferably, the image processing apparatus further comprises: a second two-dimensional image generation unit for generating a second two-dimensional image in accordance with the projection of the three-dimensional image data on the segmentation curved surface along the first predetermined direction; a third two-dimensional image generation unit for generating a third two-dimensional image in accordance with the projection of the three-dimensional image data along a direction vertical to the first predetermined direction; and a control point designation unit for designating the designated control point in the third two-dimensional image, wherein the display unit is further used for displaying the second two-dimensional image and the third two-dimensional image, and the display unit also displays the first two-dimensional image at a corresponding position of the second two-dimensional image in the form of window so as to cover the corresponding part of the second two-dimensional image.

Preferably, the segmentation curved surface generation unit generates the segmentation curved surface with points having a same attribute as that of the designated control point in accordance with the attribute of the designated control point. More preferably, the attribute is at least one selected from the group consisting of the following attributes: grayscale value of the designated control point, color value of the designated control point, gradient value and gradient direction of the designated control point. More preferably, the segmentation curved surface generation unit generates the segmentation curved surface through the use of local segmentation method by taking the designated control point as a seed.

According to the second aspect of the present invention, an image processing method is proposed, which comprises: generating a segmentation curved surface passing through a designated control point and intersecting with a first predetermined direction in accordance with the three-dimensional image data; and generating a first two-dimensional image in accordance with the projection of the three-dimensional image data on the segmentation curved surface.

Preferably, the segmentation curved surface is substantially vertical to the first predetermined direction. Preferably, the first two-dimensional image is generated in accordance with the projection of the three-dimensional image data on the segmentation curved surface along the first predetermined direction.

Preferably, the first two-dimensional image is generated in accordance with the projection of the three-dimensional image data on the segmentation curved surface along a direction opposite to the first predetermined direction.

Preferably, the image processing method further comprises: generating a second two-dimensional image in accordance with the projection of the three-dimensional image data on the segmentation curved surface along the first predetermined direction; generating a third two-dimensional image in accordance with the projection of the three-dimensional image data along a direction vertical to the first predetermined direction, wherein, the designated control point is designated in the third two-dimensional; and displaying the first two-dimensional image at a corresponding position of the second two-dimensional image in the form of window so as to cover the corresponding part of the second two-dimensional image.

Preferably, each point on the segmentation curved surface has a same attribute as that of the designated control point. More preferably, the attribute is at least one selected from the group consisting of the following attributes: grayscale value of the designated control point, color value of the designated control point, gradient value and gradient direction of the designated control point. More preferably, the segmentation curved surface is generated through the use of local segmentation method by taking the designated control point as a seed.

According to the present invention, a user can select, from a rendering window of a three-dimensional scene, a sub-window which is used for rendering an object or its specific part occluded by an opaque object in a three-dimensional scene along a sight line.

According to the present invention, the sub-window selected by the user from the volume rendering window is called focus window, the user can change its shape and size, and move it within the volume rendering window.

According to the present invention, an object to be rendered is selected by the user from a plane orthogonal to the focus window. The orthogonal plane is parallel to the sight line and passes through the object to be rendered or its specific part and shows the profile information of that the orthogonal plane passes through the three-dimensional scene. The information may be obtained by sampling the three-dimensional data, may also be the results obtained from common rendering technique, such as volume rendering method, in which the plane is taken as a projection plane.

According to the present invention, the intersection line of the orthogonal plane and the projection plane is located in a sub-window which is selected by a user, and the user can adjust its position in the focus window, so that the position of user-interested object can be rapidly located by adjusting position of the orthogonal plane in the volume data.

According to the present invention, the orthogonal plane provides a control point for selecting the user-interested object, the user can move the control point to near the edge of interested object, and the system automatically generates a two-dimensional surface to separate the object of interest from the other objects in the direction of light according to the control point. The range of the segmentation curved surface is limited within a focus space which takes the focus window as a bottom, wherein the height of the focus space is parallel to the sight line.

According to the present invention, the segmentation curved surface divides all the lights emitted from the focus window into two parts, one part passes through the opaque area in front of the interested object, and the other part irradiates the object of interest directly, and the user-interested object can be shown through the opaque area by means of establishing different transfer functions for the two parts of lights.

According to the present invention, also the back of another interested object can be rendered by taking the segmentation curved surface as a starting point, sampling and synthesizing along the opposite direction of the light ray in the interior of the focus space.

### BRIEF DESCRIPTION OF THE DRAWINGS

FIG. 1 is a typical three-dimensional scene: a schematic illustration of a human neck;

FIG. 2 illustrates a section paralleled to the direction of sight line and orthogonal to a main window of a volume rendering;

FIG. 3 illustrates the process of generating a segmentation curve in a two-dimensional plane;

FIG. 4 illustrates, in a three-dimensional space, a focus space and a section which is located therein and has been shown in FIG. 2 (called ‘object selection surface’);

FIG. 5 illustrates a segmentation curved surface generated according to an object selection point in a focus space. The segmentation curved surface can divide all lines of sight within the focus space into two parts;

FIG. 6 shows an example obtained from the rendering results in a focus window;

FIG. 7 illustrates another function of a segmentation curved surface, which enables the user to render a back side of the user-interested object without moving the position of view point;

FIG. 8 illustrates a situation in which three objects occlude each other in a three-dimensional space, and the user can select an object to be rendered according to the need;

FIG. 9 is an interface design of a system, which mainly comprises a main window of volume rendering, a focus window, an object selection window and some control buttons;

FIG. 10 and FIG. 11 are schematic diagrams used to describe how to select the size of a focus window;

FIG. 12 is an operation flow chart of the system;

FIG. 13 is a block diagram showing hardware structure of the system; and

FIG. 14 is a block diagram showing hardware structure of the system in detail.

### DETAILED DESCRIPTION OF THE EMBODIMENT

The embodiment of this invention is described with reference to the drawings hereafter, wherein some details and functions unnecessary for the present invention is omitted so as to prevent misunderstanding of the present invention.

The present invention solves the problem that the user-interested object occluded by other opaque objects can not be rendered in a volume rendering.

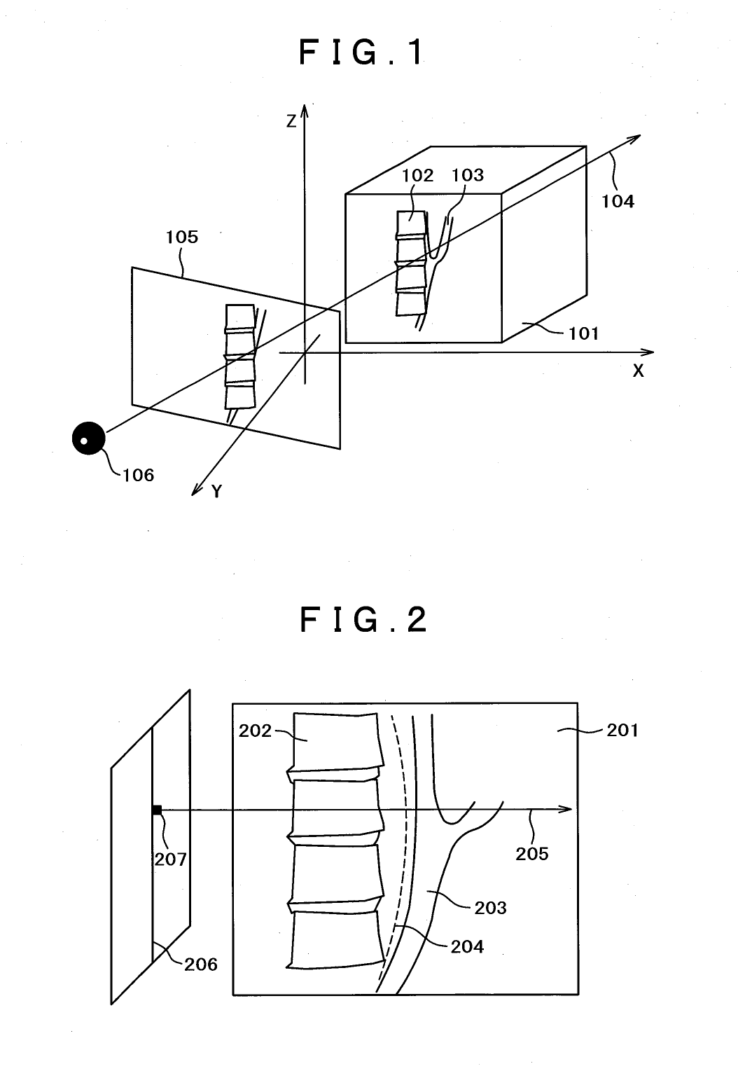

FIG. 1 is a typical three-dimensional scene, wherein, volume data 101 is a schematic illustration of CT scan data for a human neck, two main tissues of cervical vertebra 102 and carotid artery 103 are presented in the figure. A ray 104 is a sight line emitted from a view point 106, the ray 104 is vertical to a projection plane 105 (position of the view point of the parallel projection volume rendering is in infinite distance) in a parallel projection mode, and passes through the three-dimensional data. In the ray projection volume rendering algorithm, a pixel of the projection plane 105 is corresponding to a light ray parallel to the direction of sight line, a set of light ray is emitted from the projection plane and enters into the interior of the three-dimensional data to perform re-sampling, and generates corresponding pixel color value on the projection plane with the aid of synthetic function, so that a complete volume rendering result is produced after all the sight lines have been synthesized. In the traditional volume rendering process, the light ray first meets the cervical vertebra, since the cervical vertebra has a much larger grayscale value than carotid artery, and has a higher opacity value, at the same time, the sampling point came in behind in the synthetic function has a less contribution to the result, therefore, the part of carotid artery occluded by cervical vertebra will not be seen in the last result. Because the projection plane is located in the exterior of the volume data, the light ray can not avoid cervical vertebra and reach the carotid artery directly. The present invention proposes a solution which enables to render the part of a carotid artery occluded by the cervical vertebra directly through the cervical vertebra which has a high grayscale value.

FIG. 2 shows a section 201 parallel to the sight line and intersecting with the volume data in the space shown in FIG. 1. The section 201 and the projection plane intersect at a line segment 206 which is the projection of section 201 in the projection plane along the sight line. A pixel 207 is on the intersection line 206, and a light ray 205 emitted from the pixel 207 is on the section 201. The section 201 shows the profile information of cervical vertebra 202 and carotid artery 203 thereon. The light ray 205 reaches the cervical vertebra 202 first, in the synthesis process performed from front to back, the sampling point located at the front part of the light ray has a greater weight in a synthetic function of the volume rendering, and cervical vertebra 202 has a larger opacity, therefore, the cervical vertebra 202 will obstruct the carotid artery standing behind it in the rendering result. A curve 204 is an ideal curve in the section 201, which can separate cervical vertebra 202 from carotid artery 203 and distribute them to both side of the curve. In this way, the curve 204 also cut the light ray 205 into two parts: one part on the left of the curve 204 passing through the cervical vertebra, and the other part on the right of the curve 204 passing through the carotid artery, thus, enabling to establish different transfer functions and take a flexible synthesis method for the sampling points located separately on the two parts of the light ray, for example, delete the sampling points passing through the cervical vertebra 202 directly from the synthesis function, thereby, showing the carotid artery 203 directly through the cervical vertebra 202.

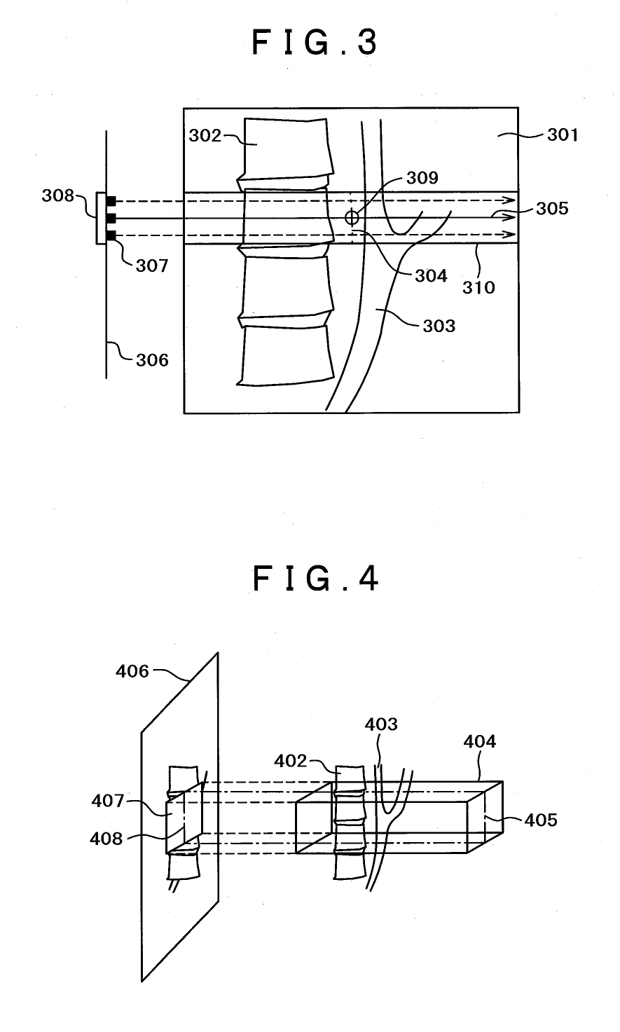

FIG. 3 illustrates how to find the correct segmentation curve 304 in a section 301. A projection plane and an orthogonal plane on which a section 301 is located intersect at a line 306, and a line segment 308, called ‘focus segment’, is selected within the intersection line 306, so as to form a new object selection surface 310 by taking the focus segment 308 as a width and taking the sight line as a height. A control point 309 is provided inside the object selection surface 310, herein called ‘object selection point’, which is used for locating and selecting user-interested object. On the basis of a voxel which the object selection point 309 corresponds to, a curve 304 is generated automatically within the object selection surface 310. The curve 304 can separate cervical vertebra 302 from carotid artery 303 inside the object selection surface and so it is called ‘segmentation curve’. The segmentation curve 304 divides a light ray 305 emitted from a pixel 307 on the focus segment 308 into two parts, thereby enabling to establish different transfer functions for them so as to render the carotid artery obstructed by the cervical vertebra.

FIG. 4 is an expansion in three-dimensional space based on FIG. 3, wherein a sub-window 407 is selected in the volume rendering window of a projection plane 406, called ‘focus window’. A three-dimensional space is defined by taking the focus window 407 as a bottom and the sight line as a height, a part of the three-dimensional space that is located within the volume data is called focus space 404. An object selection surface 405 is positioned inside the focus space 404 and parallel to the direction of sight line, and intersects with the focus window 407 at a line segment 408 which is called ‘control line’, position (and angle) of the object selection surface 405 in the volume data can be adjusted by controlling position (and angle) of the control line 408, so as to quickly locate the object of interest in the volume data. When a point (object selection point) located between cervical vertebra 402 and carotid artery 403 or at the edge of the carotid artery 403 is selected in the object selection surface by the user, the system automatically generates a segmentation curved surface in the focus space 404 on the basis of the point, and this surface can separate the cervical vertebra from the carotid artery.

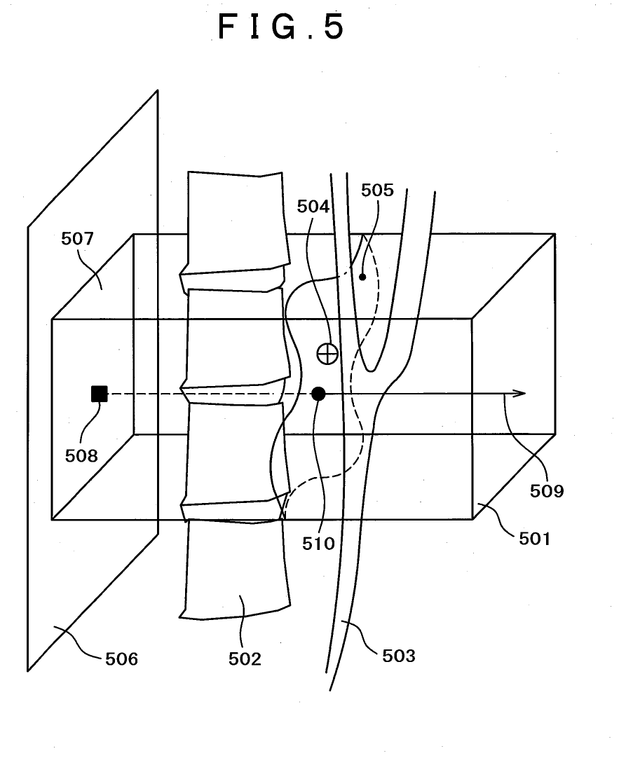

FIG. 5 illustrates a segmentation curved surface 505 which is positioned between cervical vertebra 502 and carotid artery 503 in a focus space 501, and an object selection point 504 is located thereon. A light ray 509 emitted from a pixel 508 in a focus window 507 which is positioned on a projection plane 506 intersects with the segmentation curved surface 505 at a voxel 510 that will be taken as a boundary point in the volume rendering process along the light ray. The segmentation curved surface 505 is generated by using local segmentation method in the focus space on the basis of the object selection point 504 selected by a user, for example, the object selection point is taken as a seed point which grows according to a certain condition and direction in the focus space. Region growing is a basic image segmentation method, which is a processing method of merging the pixels or regions into a larger region in accordance with a predefined growing criterion. A basic processing method is: forming a growing region by starting from a group of ‘seed points’, then adding those neighborhood pixels which are similar to the seed, finally, segmenting out the region having the same attribute through iteration. In the present invention, the attribute can be a grayscale value of the object selection point, a color value of the object selection point, or a gradient value and gradient direction of the object selection point. In the three-dimensional data shown in FIG. 5, the space between cervical vertebra 502 and carotid artery 503 is a background region, voxels located inside background region can be distinguished from the voxels in the cervical vertebra and the carotid artery by using a fixed threshold value T, moreover, the object selection point 504 is also in the background region, in this case, the growing condition, i.e., the similarity criterion, can be established as: whether the value of voxels neighboring the seed point is within the range of background voxel value, and the growing direction is used to ensure that the projection of already generated surface in the focus window 507 has a monotonous growth, thereby ensuring the segmentation curved surface 505 and each light ray emitted from the focus window 507 have only one intersection point. For other more complex situations, for example, in a case of no background point exiting in a specific part between the cervical vertebra and the carotid artery, a simple threshold value can not be used as a growing condition. Therefore, it is necessary to design more effective growing conditions in order to generate the segmentation curved surface 505 accurately.

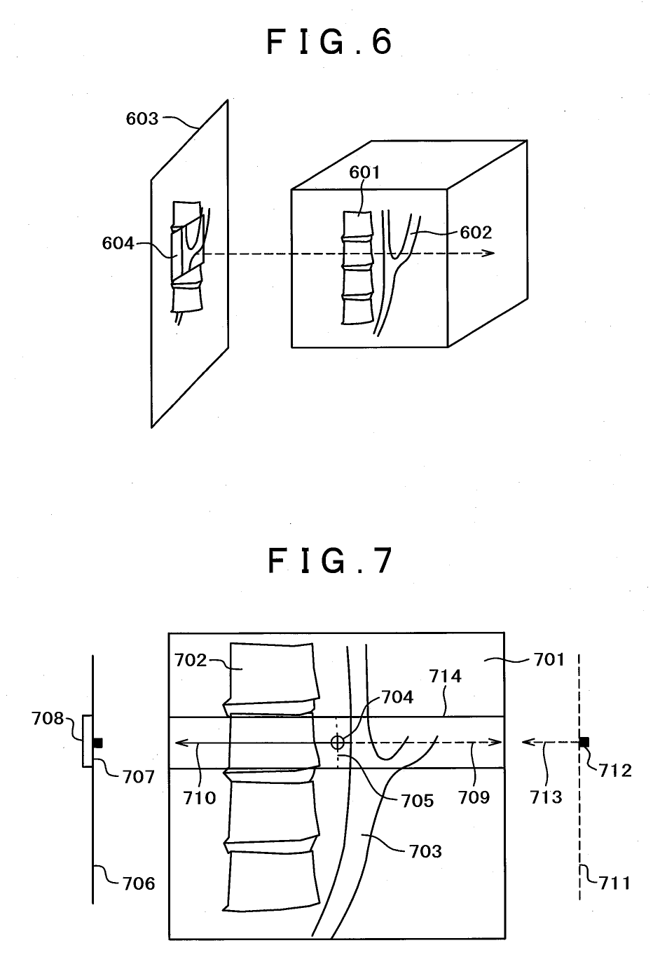

FIG. 6 shows a result obtained by using this method, a part of carotid artery 602 occluded by cervical vertebra 601 in a volume rendering main window 603 is displayed in a focus window 604.

FIG. 7 illustrates another method of using a segmentation curved surface 705. A projection plane and an orthogonal plane on which a section 701 is located intersect at a line 706, a focus segment 708 is selected within the intersection line 706, so as to form a new object selection surface 714 by taking the focus segment 708 as a width and taking the sight line as a height. After the segmentation curved surface 705 is determined according to an object selection point 704, the direction of sight line may have two selections: one is along the original direction of sight line 709 to perform a foreword sampling, thereby, enabling to render the front scene of carotid artery 703; another is sampling along the direction 710 which is opposite to the original sight line 709, thereby, getting a rendering result which shows the back scene of cervical vertebra 702, this effect is equivalent to rendering result of rotating the position of view point 180°, meanwhile, skipping over the carotid artery 703 (the intersection line 706 and pixel 707 are respectively rotated to intersection line 711 and pixel 712, and the direction of sight line is rotated to 713). In this way, the working efficiency of radiologists can be improved greatly.

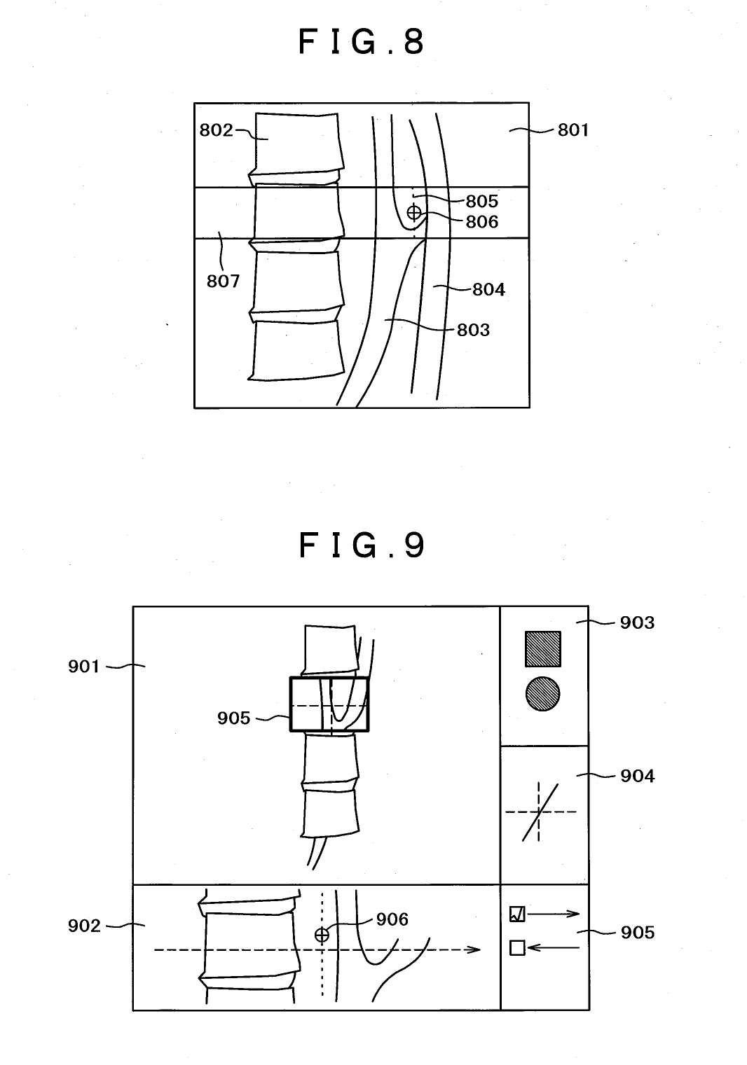

FIG. 8 illustrates a more complicated three-dimensional scene showing a section 801 contains three tissues: cervical vertebra 802, carotid artery 803 and internal jugular vein 804, wherein a partial region on the right side of the carotid artery 803 is occluded by the internal jugular vein 804. By selecting a voxel near the edge region of an object to be rendered as a starting point, for example, a voxel 806 located in the middle of the carotid artery 803 and the internal jugular vein 804 in FIG. 8, a user can generate a corresponding segmentation curved surface. The segmentation curved surface 805 generated from the voxel 806 separates the carotid artery 803 from the internal jugular vein 804 inside an object selection surface 807. By taking the intersection point of the segmentation curved surface and the sight line as a starting point, and performing sampling and synthesis along the direction of sight line, a rendering result of the front part of the internal jugular vein 804 can be obtained, while performing sampling and synthesis along the opposite direction of sight line, a rendering result of the back part of the carotid artery 803 can be obtained.

FIG. 9 is a user operating interface of a system, wherein a main window 901 of the system is a projection plane of three-dimensional data rendering; a mark 903 is a focus window selecting button, two options are provided for the focus window selection in FIG. 9: one rectangular and one circular. A user can select one type, e.g., the rectangular focus window 905 shown in FIG. 9, and drag it into the main window 901, then change the attribute of length and width of the focus window 905 in the main window 901, at the same time, can also select different regions by dragging it. A mark 904 represents a control area of a focus segment, and the focus segment is a line segment, the center of which is located in the focus window, the length of which is limited within the focus window. User can change the angle of focus segment through control region 904. A mark 902 represents a section parallel to the sight line and orthogonal to the main projection plane, the position of the section is controlled by the focus segment, and the intersection line of the section and the main projection plane overlaps with the focus segment. This section is used to display two-dimensional profile information in the direction of sight line, thus, providing the user with profound information. The user system offers a control point 906 used for locating the user-interest object, its initial position is on the left of the section 902. The user can drag the control point 906 and move it to near the edge of the user-interest object, then the system automatically detect the position of control point 906, and generate, after the position has been fixed, a segmentation curved surface in the interior of the focus space on the basis of the position. This surface can control the initial position of sampling point in the process of volume rendering, thereby, getting the rendering result of the focus window 905 in the main window 901, that is, to see the front side of the carotid artery through the cervical vertebra.

Size of the focus window 905 can be selected freely by the user, and the free adjustment of the focus window size provides the user a more flexible and controllable displaying mode although the shape and distribution of the objects in three-dimensional data are more complex usually.

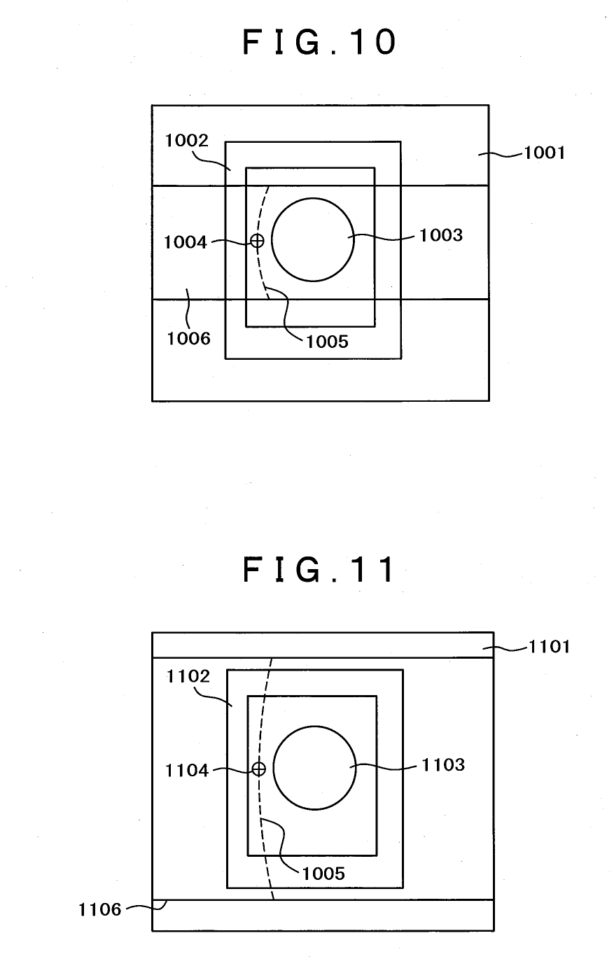

FIG. 10 illustrates another simple and common three- dimensional scene, wherein a spherical object 1003 is contained in a closed cuboid box 1002, a section 1001 is a section parallel to the sight line as described above. An object selection surface 1006 is a region which is limited within a focus space in the section 1001. A control point 1004 is selected at the position between the spheroid 1003 and the cuboid 1002 within the object selection surface 1006 by means of the abovementioned method, and a surface 1005 is generated to separate the spheroid 1003 and the cuboid 1002, thus, a complete sphere is displayed in the focus window at last.

As shown in FIG. 11, if the size of focus window is adjusted to make an object selection surface 1106 in a section 1101 cover a cuboid 1102 and a spheroid 1103 at the same time, then a segmentation curved surface 1105 passing through a control point 1104 will penetrate the cuboid 1102, in this case, the contents displayed in the focus window are not only a part of spheroid 1103, but also a partial region of the cuboid 1102 which is covered by the segmentation curved surface, and the contents of this part is determined by the method of surface generation, since the different methods lead to different results, its information is often no real meaning except for providing a relative position information of the cuboid and the spheroid in the focus window. If a user enlarges the focus window continuously, the proportion of the meaningless information will increase, thereby, resulting in an adverse effect to user's observation of the interested object. Therefore, an appropriate window size should be determined according to the size of object to be observed and the distribution of surrounding objects, and so it is necessary for the user to adjust the size of window constantly.

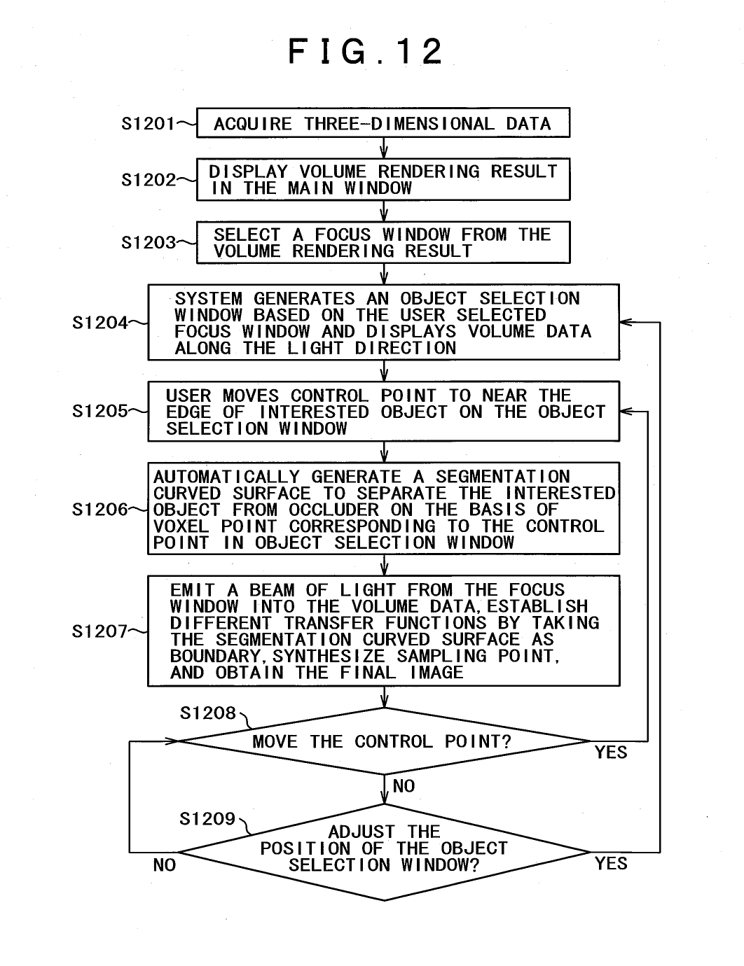

FIG. 12 is a system operation flow chart. Firstly, in step S1201, three-dimensional data such as a regular three-dimensional CT scan data is acquired; Then, in step S1202, rendering for the three dimensional-data is performed from a selected viewpoint by using traditional volume rendering algorithms (such as ray casting algorithm) on a two-dimensional screen, and the result is stored in a frame buffer of two-dimensional display and displayed in the main window of the user interface;

in step S1203, the user selects a focus window from the operational interface and dragged into the main window by the user;
afterward, in step S1204, the system will automatically generate a section vertical to the focus window and display it in an object selection window;
in step S1205, the user can see the three-dimensional data in the direction of sight line, so as to select an object of interest in this direction. There is a control point used for selecting the object of interest in the object selection window, the user can move the control point to near the edge of the interested object in the object selection window;
in step S1206, the system automatically generates a surface to separate the interested object from neighboring object on the basis of the control point. The produced segmentation curved surface divides the light ray emitted from a pixel in the focus window into two parts, one part passing through the object part obstructing the interested object, the other directly irradiating the surface of the interested object;
in step S1207, the system can carry on sampling and synthesis individually for the second part of the light ray to show the object of interest directly, also can design different transfer functions for the two parts of light to turn the partial area standing in front of the interested object into semi-transparence;
in step S1208, the user may continue to move the control point in order to select other object;
in step S1209, the user can also locate the object of interest by adjusting position and size of the focus window, at the same time, can also adjust the space projection location of an object selection surface by means of controlling projection segment of the object selection surface in the focus window, and the content of object selection surface is updated constantly with the position of object selection surface in the volume data.

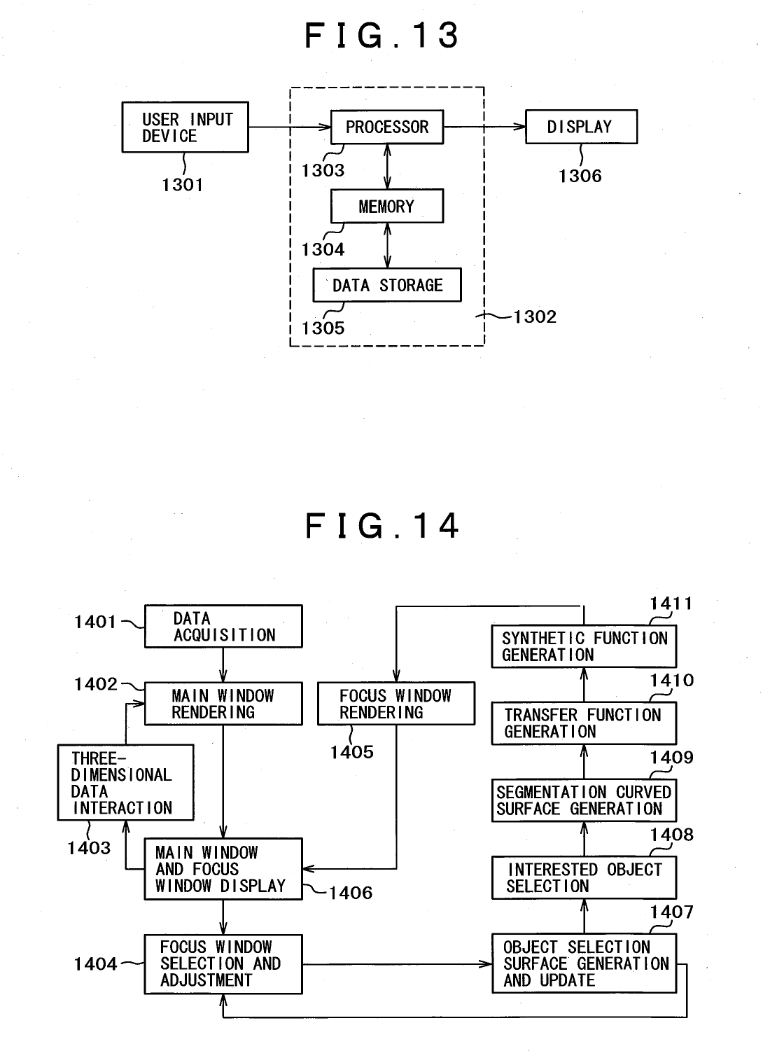

FIG. 13 is a block diagram showing the hardware structure of the system.

A computer 1302 is a general computer mainly comprising a processor unit 1303, a memory unit 1304 and a data storage unit 1305. A user input device 1301 and a display unit 1306 implement the interactive tasks together between the user and the computer. The processor 1303 and the memory device 1304 carry on the user-required data processing in accordance with the user interaction.

FIG. 14 is a block diagram showing the hardware structure of the system in detail.

A data acquisition unit 1401 is used for collecting three-dimensional data such as regular three-dimensional CT scan data and so on. A main window rendering unit 1402 (the second two-dimensional image generation unit) accomplishes three-dimensional rendering from a certain view point. A three-dimensional data interaction unit 1403 enables the user to select a specific view point to observe three-dimensional object. A focus window selection and adjustment unit 1404 allows the user to select different shape of the focus window, and adjust its size and position in the main window. An object selection surface generation and update unit 1407 (the third two-dimensional image generation unit) updates the contents of display according to the position and shape of the focus window. An interested object selection unit 1408 (a control point designation unit) provides a function of selecting interested object in the object selection surface. A segmentation curved surface generation unit 1409 automatically generates a segmentation curved surface based on the position of an object selection control point which is selected by the user. A transfer function generation unit 1410 divides the light ray emitted from the focus window into two parts and establishes different transfer functions according to the segmentation curved surface generated by the unit 1409, that is, setting the color and opacity values for the three-dimensional data voxel which is passed through by the light ray. A focus window rendering unit 1405 (the first two-dimensional image generation unit) performs rendering for the three-dimensional data included in a focus space by using the synthetic function generated from a synthetic function generation unit 1411, and displays the results in the focus window.

In the above description, plural examples is given with regard to each step. Although the inventor tried to indicate the examples which are interconnected as much as possible, this does not mean that these examples must have a corresponding relation according to their respective mark numbers. As long as there are no contradictions among the conditions given by the selected examples, it is possible to select examples which do not have corresponding numbers in different steps to constitute the technical solution. Such technical solution should also be regarded as included in the scope of the present invention.

It is noteworthy that, the technical solution of the present invention is illustrated only by way of demonstration in the above description, however, this does not mean that the invention is limited to the above steps and unit structures. Under possible circumstances, it is possible to make adjustment and selection of steps and unit structures. Accordingly, some steps and unit structures are not essential elements to implement the overall thinking of the invention. Therefore, the necessary technical features of the present invention is only restricted by the lowest requirements to implement the overall thinking of the invention, and not restricted by the above specific examples.

The other setting disclosed here in the embodiments of the present invention includes the software program executing and operating the steps of the embodiments which have been briefly introduced first and elaborated later. More concretely, the product of the computer program is the flowing embodiment, which comprises a computer readable medium having a computer program logic coded thereon, when executed on a computing equipment, the computer program logic provides relevant operations, thus, providing abovementioned one-way agent transfer encryption scheme. When implemented on at least one processor of the computing system, the computer program logics makes the processor perform the operation (method) described in the embodiments of the invention. The setting of the present invention can be provided typically as a software, a code and/or other data structures set or encoded on computer readable media, such as optical media (e.g. CD-ROM), soft disk, hard disk and the like, or as a firmware on chips such as one or more Rom or RAM or PROM or other media of microcode, or as a downloadable software image or shared database etc. in an application specific integrated chip (ASIC) or one or more modules. Software or firmware or such a configuration can be installed on a computing equipment to make one or more processors of the computing equipment implement the technology described in the embodiments of the present invention. The system according to the present invention can also be provided by software processes operated by combining a set of data communication equipments or computing equipments in other entities. The system according to the present invention can also be distributed among plural software processes on plural data communication equipments, or all the software processes operated on a set of dedicated minicomputers, or all the software processes operated on individual computers.

To be understood, strictly speaking, the embodiments of the present invention can be realized as a software program, software and hardware, or individual software and/or an independent electric circuit on data communication equipments.

The present invention has been described in combination with the preferred embodiments thereof. It is to be understood that other various modifications, replacements and adjunctions can be made herein without departing from the spirit and scope of the invention by those skilled in the art. Therefore, the scope of the present invention is not limited by the specific embodiments described above, but defined only by the appended claims instead.

1. An image processing apparatus, comprising:
a segmentation curved surface generation unit for generating a segmentation curved surface passing through a designated control point and intersecting with a first predetermined direction in accordance with three-dimensional image data;
a first two-dimensional image generation unit for generating a first two-dimensional image in accordance with the projection of the three-dimensional image data on the segmentation curved surface; and
a display unit for displaying the first two-dimensional image generated by the first two-dimensional image generation unit.

2. The image processing apparatus according to claim 1, wherein the segmentation curved surface generated by the segmentation curved surface generation unit is substantially vertical to the first predetermined direction.

3. The image processing apparatus according to claim 1, wherein the first two-dimensional image generation unit generates the first two-dimensional image in accordance with the projection of the three-dimensional image data on the segmentation curved surface along the first predetermined direction.

4. The image processing apparatus according to claim 1, wherein the first two-dimensional image generation unit generates the first two-dimensional image in accordance with the projection of the three-dimensional image data on the segmentation curved surface along a direction opposite to the first predetermined direction.

5. The image processing apparatus according to claim 1, further comprising:
a second two-dimensional image generation unit for generating a second two-dimensional image in accordance with the projection of the three-dimensional image data on the segmentation curved surface along the first predetermined direction;
a third two-dimensional image generation unit for generating a third two-dimensional image in accordance with the projection of the three-dimensional image data along a direction vertical to the first predetermined direction; and
a control point designation unit for designating the designated control point in the third two-dimensional image,
wherein the display unit is further used for displaying the second two-dimensional image and the third two-dimensional image, and the display unit also displays the first two-dimensional image at a corresponding position of the second two-dimensional image in the form of window so as to cover the corresponding part of the second two-dimensional image.

6. The image processing apparatus according to claim 1, wherein the segmentation curved surface generation unit generates the segmentation curved surface with points having a same attribute as that of the designated control point in accordance with the attribute of the designated control point.

7. The image processing apparatus according to claim 6, wherein the attribute is at least one selected from the group consisting of the following attributes: grayscale value of the designated control point, color value of the designated control point, gradient value and gradient direction of the designated control point.

8. The image processing apparatus according to claim 6, wherein the segmentation curved surface generation unit generates the segmentation curved surface through the use of local segmentation method by taking the designated control point as a seed.

9. An image processing method, comprising the steps of:
generating a segmentation curved surface passing through a designated control point and intersecting with a first predetermined direction in accordance with three-dimensional image data;
generating a first two-dimensional images in accordance with the projection of the three-dimensional image data on the segmentation curved surface.

10. The image processing method according to claim 9, wherein the segmentation curved surface is substantially vertical to the first predetermined direction.

11. The image processing method according to claim 9, wherein the first two-dimensional image is generated in accordance with the projection of the three-dimensional image data on the segmentation curved surface along the first predetermined direction.

12. The image processing method according to claim 9, wherein the first two-dimensional image is generated in accordance with the projection of the three-dimensional image data on the segmentation curved surface along a direction opposite to the first predetermined direction.

13. The image processing method according to claim 9, further comprising the steps of:
generating a second two-dimensional image in accordance with the projection of the three-dimensional image data on the segmentation curved surface along the first predetermined direction;
generating a third two-dimensional image in accordance with the projection of the three-dimensional image data along a direction vertical to the first predetermined direction, wherein, the designated control point is designated in the third two-dimensional image; and
displaying the first two-dimensional image at a corresponding position of the second two-dimensional image in the form of window so as to cover the corresponding part of the second two-dimensional image.

14. The image processing method according to claim 9, wherein each point on the segmentation curved surface has a same attribute as that of the designated control point.

15. The image processing method according to claim 14, wherein the attribute is at least one selected from the group consisting of the following attributes: grayscale value of the designated control point, color value of the designated control point, gradient value and gradient direction of the designated control point.

16. The image processing method according to claim 14, wherein the segmentation curved surface is generated through the use of local segmentation method by taking the designated control point as a seed.
